(19) United States
(12) Patent Application Publication
(10) Pub. No.: US 2002/0044994 A1
(43) Pub. Date: Apr. 18, 2002

(54) METHOD OF IMPROVING PROCESSES FOR MANUFACTURING CITRUS FRUIT JUICE USING NOBLE GASES

(76) Inventor: KEVIN C SPENCER, HINSDALE, IL (US)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 08/328,534

(22) Filed: Oct. 25, 1994

Related U.S. Application Data
(63) Continuation of application No. 07/982,465, filed on Nov. 27, 1992, now abandoned.
Application No. 07/982,465 is a continuation-in-part of application No. 07/863,655, filed on Apr. 3, 1992, now abandoned.

(51) Int. Cl. A23L 2/00

(52) U.S. Cl. 426/312; 426/599

(57) ABSTRACT

A method of improving the aromas or the flavor or both of a cutrus juice or precursor thereof, comprising injecting a gas or gas mixture into the citrus juice or precursor thereof or both in containing means or into containing means therefor, the gas or gas mixture containing an element selected from the group consisting of argon, krypton, xenon, neon and a mixture thereof; substantially saturating the citrus juice or precursor thereof with said gas or gas mixture, maintaining said saturation substantially throughout the volume of the containing means and during substantially throughout the duration that the citrus juice or precursor is stored in the containing means.

The present application is a continuation-in-part (CIP) application of Ser. No. 07/863,655 filed on Apr. 3, 1992.

### BACKGROUND OF THE INVENTION

1. Field of the Invention

The present invention relates to a method of improving processes for manufacturing citrus fruit juice using noble gases.

2. Discussion of the Background

The ability of the noble gases helium (He), neon (Ne), argon (Ar), krypton (Kr), xenon (Xe) and radon (Ra) to enter into chemical combination with other atoms is extremely limited. Generally, only krypton, xenon and radon have been induced to react with other atoms which are highly reactive, such as fluorine and oxygen, and the compounds thus formed are explosively unstable. See Advanced Inorganic Chemistry, by F. A. Cotton and G. Wilkinson (Wiley, Third Edition). However, while the noble gases are, in general, chemically inert, xenon is known to exhibit certain physiological effects, such as anesthesia. Other physiological effects have also been observed with other inert gases such as nitrogen, which, for example, is known to cause narcosis when used under great pressure in deep-sea diving.

It has been reported in U.S. Pat. No. 3,183,171 to Schreiner that argon and other inert gases can influence the growth rate of fungi and argon is known to improve the preservation of fish or seafood. U.S. Pat. No. 4,946,326 to Schvester, JP 52105232, JP 80002271 and JP 77027699. However, the fundamental lack of understanding of these observations clearly renders such results difficult, if not impossible, to interpret. Moreover, the meaning of such observations is further obscured by the fact that mixtures of many gases, including oxygen, were used in these studies. Further, some of these studies were conducted at hyperbaric pressures and at freezing temperatures. At such high pressures, it is likely that the observed results were caused by pressure damage to cellular components and to the enzymes themselves.

For example, from 1964 to 1966, Schreiner documented the physiological effects of inert gases particularly as related to anesthetic effects and in studies relating to the development of suitable containment atmospheres for deep-sea diving, submarines and spacecraft. The results of this study are summarized in three reports, each entitled: “Technical Report. The Physiological Effects of Argon, Helium and the Rare Gases,” prepared for the Office of Naval Research, Department of the Navy. Contract Nonr 4115(00), NR: 102-597. Three later summaries and abstracts of this study were published.

One abstract, “Inert Gas Interactions and Effects on Enzymatically Active Proteins,” Fed. Proc. 26:650 (1967), restates the observation that the noble and other inert gases produce physiological effects at elevated partial pressures in intact animals (narcosis) and in microbial and mammalian cell systems (growth inhibition).

A second abstract, “A Possible Molecular Mechanism for the Biological Activity of Chemically Inert Gases,” In: Intern. Congr. Physiol. Sci., 23rd, Tokyo, restates the observation that the inert gases exhibit biological activity at various levels of cellular organization at high pressures.

Also, a summary of the general biological effects of the noble gases was published by Schreiner in which the principal results of his earlier research are restated. “General Biological Effects of the Helium-Xenon Series of Elements,” Fed. Proc. 27:872-878 (1968).

However, in 1969, Behnke et al refuted the major conclusions of Schreiner. Behnke et al concluded that the effects reported earlier by Schreiner are irreproducible and result solely from hydrostatic pressure, i.e., that no effects of noble gases upon enzymes are demonstrable. “Enzyme-Catalyzed Reactions as Influenced by Inert Gases at High Pressures.” J. Food Sci. 34:370-375.

In essence, the studies of Schreiner were based upon the hypothesis that chemically inert gases compete with oxygen molecules for cellular sites and that oxygen displacement depends upon the ratio of oxygen to inert gas concentrations. This hypothesis was never demonstrated as the greatest observed effects (only inhibitory effects were observed) were observed with nitrous oxide and found to be independent of oxygen partial pressure. Moreover, the inhibition observed was only 1.9% inhibition per atmosphere of added nitrous oxide.

In order to refute the earlier work of Schreiner, Behnke et al independently tested the effect of high hydrostatic pressures upon enzymes, and attempted to reproduce the results obtained by Schreiner. Behnke et al found that increasing gas pressure of nitrogen or argon beyond that necessary to observe a slight inhibition of chymotrypsin, invertase and tyrosinase caused no further increase in inhibition, in direct contrast to the finding of Schreiner.

The findings of Behnke et al can be explained by simple initial hydrostatic inhibition, which is released upon stabilization of pressure. Clearly, the findings cannot be explained by the chemical-O₂/inert gas interdependence as proposed by Schreiner. Behnke et al concluded that high pressure inert gases inhibit tyrosinase in non-fluid (i.e., gelatin) systems by decreasing oxygen availability, rather than by physically altering the enzyme. This conclusion is in direct contrast to the findings of Schreiner.

In addition to the refutation by Behnke et al, the results reported by Schreiner are difficult, if not impossible, to interpret for other reasons as well.

First, all analyses were performed at very high pressure, and were not controlled for hydrostatic pressure effects.

Second, in many instances, no significant differences were observed between the various noble gases, nor between the noble gases and nitrogen.

Third, knowledge of enzyme mode of action and inhibition was very poor at the time of these studies, as were the purities of enzymes used. It is impossible to be certain that confounding enzyme activities were not present or that measurements were made with a degree of resolution sufficient to rank different gases as to effectiveness. Further, any specific mode of action could only be set forth as an untestable hypothesis.

Fourth, solubility differences between the various gases were not controlled, nor considered in the result.

Fifth, all tests were conducted using high pressures of inert gases superimposed upon 1 atmosphere of air, thus providing inadequate control of oxygen tension.

Sixth, all gas effects reported are only inhibitions.

Seventh, not all of the procedures in the work have been fully described, and may not have been experimentally controlled. Further, long delays after initiation of the enzyme reaction precluded following the entire course of reaction, with resultant loss of the highest readable rates of change.

Eighth, the reported data ranges have high variability based upon a small number of observations, thus precluding significance.

Ninth, the levels of inhibition observed are very small even at high pressures.

Tenth, studies reporting a dependence upon enzyme concentration do not report significant usable figures.

Eleventh, all reports of inhibitory potential of inert gases at low pressures, i.e., <2 atm., are postulated based upon extrapolated lines from high pressure measurements, not actual data.

Finally, it is worthy of reiterating that the results of Behnke et al clearly contradict those reported by Schreiner in several crucial respects, mainly that high pressure effects are small and that hydrostatic effects, which were not controlled by Schreiner, are the primary cause of the incorrect conclusions made in those studies.

Additionally, although it was reported by Sandhoff et al, FEBS Letters, vol. 62, no. 3 (March, 1976) that xenon, nitrous oxide and halothane enhance the activity of particulate sialidase, these results are questionable due to the highly impure enzymes used in this study and are probably due to inhibitory oxidases in the particles.

To summarize the above patents and publications and to mention others related thereto, the following is noted.

Behnke et al (1969), disclose that enzyme-catalyzed reactions are influenced by inert gases at high pressures. J. Food Sci. 34: 370-375.

Schreiner et al (1967), describe inert gas interactions and effects on enzymatically, active proteins. Abstract No. 2209. Fed. Proc. 26:650.

Schreiner, H. R. 1964, Technical Report, describes the physiological effects of argon, helium and the rare gases. Contract Nonr 4115 (00), NR: 102-597. Office of Naval Research, Washington, D.C.

Schreiner, H. R. 1965, Technical Report, describes the physiological effects of argon, helium and the rare gases. Contract Nonr 4115 (00), NR: 102-597. Office of Naval Research, Washington, D.C.

Schreiner, H. R. 1966, Technical Report, describes the physiological effects of argon, helium and the rare gases. Contract Nonr 4115 (00), NR: 102-597. Office of Naval Research, Washington, D.C.

Doebbler, G. F. et al, Fed. Proc. Vol. 26, p. 650 (1967) describes the effect of pressure or of reduced oxygen tension upon several different enzymes using the gases Kr, Xe, SF₆, N₂O, He, Ne, Ar and N₂. All gases were considered equal in their effect.

Colten et al, Undersea Biomed Res. 17(4), 297-304 (1990) describes the combined effect of helium and oxygen with high pressure upon the enzyme glutamate decarboxylase. Notably, only the hyperbaric inhibitory effect of both helium and oxygen and the chemical inhibitory effect of oxygen was noted.

Nevertheless, at present, it is known that enzyme activities can be inhibited in several ways. For example, many enzymes can be inhibited by specific poisons that may be structurally related to their normal substrates. Alternatively, many different reagents are known to be specific inactivators of target enzymes. These reagents generally cause chemical modification at the active site of the enzyme to induce loss of catalytic activity, active-site-directed irreversible inactivation or affinity labeling. See Enzymatic Reaction Mechanisms by C. Walsh (W. H. Freeman & Co., 1979). Alternatively, certain multi-enzyme sequences are known to be regulated by particular enzymes known as regulatory or allosteric enzymes. See Bioenergetics, by A. L. Leninger (Benjamin/Cummings Publishing Co., 1973).

Liquid foods, such as fruit juices or other beverages, are conventionally preserved during storage by using inert or non-reactive gases to merely displace atmospheric oxygen from their immediate vicinity, as it is known that oxygen can degrade many of the aroma and flavor components of the substances.

For example, JP 3058778 (89192663) describes the storage and maturation of alcoholic drinks, such as sake, in an argon atmosphere, whereby the argon is used simply to displace oxygen.

JP 58101667 (88019147) describes sealing of citrus drinks under pressure of argon or nitrogen as an inerting agent so that bubbles are released upon depressurization which cling attractively to the pulp.

JP 60134823 describes packaging of liquid food wherein argon or nitrogen as inert gases are used to push the product into the package.

JP 7319947 (730618) describes fruit juice preservation under inert gases, wherein Argon, Helium and Nitrogen are considered equally inert.

U.S. Pat. No. 3,128,188 describes lagering of Ruh beer under an inert atmosphere.

U.S. Pat. No. 309,181 describes a process for gas-packaging tomato juice or liquid food products or vegetable concentrates, wherein any inert gas or non-reactive gas including Argon, Nitrogen, Krypton, or Helium or mixtures thereof are completely equivalent.

U.S. Pat. No. 3,535,124 describes a fresh fruit juice dispensing system in which inert gas is used to deoxygenate during spraying.

U.S. Pat. No. 4,803,090 discloses that during cooking of foods in oils, any inert gas may be used with equivalence to displace oxygen. No significant change in the oil was noted.

Cooling of liquid foods may also be achieved using any inert or non-reactive gas. For example, see GB 1371027.

U.S. Pat. No. 4,901,887 describes a beverage dispenser which is pressurized with any inert or non-reactive gas.

EP 189442 discloses the use of inert or non-reactive gases in the heating of liquid food products while maintaining aroma and preventing boiling. Nitrogen or noble gases may be used equivalently as inert non-reactive gases.

GB 2021070 describes a beer road tanker charging system which uses an inert or non-reactive gas constituting any of carbon dioxide, nitrogen or noble gas, as equivalent as inert or non-reactive gases.

GB 1331533 describes a method of preserving alcoholic beverages wherein oxygen is displaced at any process stage, including storage, by preferably nitrogen. Argon or another noble gas may be used, as all are deemed to be equivalently inert or non-reactive.

Thus, at present, removal of oxygen from the atmosphere in contact with juices is recognized as desirable. This may be done, as already noted, by physically displacing oxygen with an inert or non-reactive gas. Furthermore, nitrogen is used preferentially because of its low cost and availability, except when carbon dioxide may be used, as it is even less expensive. For example, carbon dioxide may be used in sparkling beverages. While argon and noble gases have been used, they are explicitly described as being as inert or non-reactive gases like nitrogen, or as carbon dioxide, and are used as such.

Orange juice is extracted by various mechanical means from whole oranges in a process which is usually exposed to oxygen. Bartholomai, A. 1987. Food Factories-Processes, Equipment, Costs (VCH Publishers, New York, N.Y.). The aroma losses due to oxidation are of greatest concern during processing and particularly during storage.

Over 150 constituents of orange juice volatiles have been reported and identified, among which 40 terpene hydrocarbons, 30 esters, 36 aldehydes and ketones, 36 alcohols and 10 volatile organic acids have been isolated. An example of a chromatogram of the extracted volatiles form orange juice is given by Papanicolaou et al., J. Food Technol. 13:51IL 519 (1978).

During storage of orange juice, aroma and flavor compounds undergo many oxidative chemical reactions, which lead to the deterioration of the aroma. These reactions nay be caused by either atmospheric oxygen or by oxygen from chemical sources.

Before pasteurization of orange juice, products of oxidative enzymatic reactions can accumulate and form off-flavor compounds during storage. Bruemmer et al, J. Food Sci. 41:186-189 (1976). In unpasteurized orange juice, accumulation of acetaldehyde is probably responsible for the production of diacetyl in orange juice during storage. Diacetyl can result from oxidation of acetoin.

Orange juice contains ascorbic acid (vitamin C) which is an important antioxidant. Often, large amounts of this compound are added to commercial juice. However, it would be preferable to avoid such large additions, or to limit them, and to directly control of the chain of oxidative reactions involving ascorbic acid. Of course, oxygen degradation of aroma components in the headspace is not retarded at all by ascorbic acid, which is in solution.

Citrus juices are particularly susceptible to degradative oxidation caused by the action of oxidase enzymes or by oxygen present in the atmosphere or in solution. Displacement of this oxygen results in only a partial retardation of oxidation.

The principal problems of production quality in the citrus processing industry are clarification, color, taste, bitterness, loss of flavor, oxidation of flavor.

Proper cloud retention is a crucial quality parameter of citrus juice, which processors address by control of clarification. Loss of the appealing cloudiness of orange or other citrus juice occurs during storage due to the enzymatic action of pectinesterase. The product of pectinesterase activity is pectic acid, which chelates with divalent cations to form insoluble pectates, responsible for undesirable fruit clarification.

Presently, the only means available to stabilize (inactivate) the enzyme is heat. Unfortunately, heat is also responsible for the loss of intrinsic citrus aromas, which render citrus juices so appealing.

Naringin is the main factor responsible for bitterness in several citrus juices. Naringinase is commonly used in the citrus industry to reduce bitterness. When present in large amounts, naturally occurring naringin, or 4′,5,7-trihydroxyflavanone-7-rhamnoglucoside, is responsible for a bitter taste, which is an unappealing customer trait of grapefruit and other juices. Naringinase is an enzyme complex that contains two types of enzymatic activities (α-rhamnosidase and β-glucosidase activities), and those catalyze the breakdown of naringin into glucose and naringenin, which are not bitter.

Citrus juices can also be debittered by being passed through a hollow fiber system containing immobilized naringinase.

In preserving orange or other citrus juice, several factors are important, i.e., consistency of sweetness, tartness, color, and characteristic flavor to the consumer. Orange or other citrus juice is expected to be cloudy with suspended solids. The carbohydrate gum, pectin, helps maintain the suspension. An enzyme, pectinesterase, attacks pectin causing the juice to clarify. Some other juices are preferred to be clear (apple and cranberry, for instance). In these, enzymes may be added to promote clarification.

During storage of orange or other citrus juice, aroma and flavor compounds undergo many oxidative chemical reactions, which lead to the deterioration of the aroma. These reactions may be caused by either atmospheric oxygen or by oxygen from chemical sources.

Before pasteurization of orange or other citrus juice, products of oxidative enzymatic reactions can accumulate and form off-flavor compounds during storage (Bruemmer et al., 1976). In unpasteurized orange or other citrus juice, accumulation of acetaldehyde appears to be responsible for the production of diacetyl in orange or other citrus juice during storage. Diacetyl can result from oxidation of acetoin (Papanicolaou et al., 1978).

Moreover, orange, as well as other citrus juice, contains ascorbic acid (vitamin C) which is an important antioxidant. Often, large amounts of this compound are added to commercial juice. It would be desirable to avoid or reduce the amount of ascorbic acid added in order to have greater control over oxidative reactions involving ascorbic acid. It is also noted that oxygen degradation of aroma components in the headspace is not retarded by ascorbic acid, which is in solution.

Thus, a need exists for a means by which greater control could be obtained over the various oxidative reactions involved in the degradation of citrus juices, generally, and, specifically, over oxidative reactions involving ascorbic acid. A need also exists for a means by which diverse juices may be preserved and/or maintained, to improve the aroma and flavor thereof.

### SUMMARY OF THE INVENTION

Accordingly, it is an object of the present invention to provide a method for preserving citrus juices.

It is also an object of the present invention to provide a method for improving the aroma and flavor of stored citrus juices.

Moreover, it is a particular object of the present invention to provide a method for improving the aroma and flavor of orange juice.

The above objects and others are provided by a method fir preserving the aroma and/or flavor of citrus juice or a precursor thereof, which entails injecting a gas or gas mixture into the citrus juice or precursor thereof in a containing means or into containing means containing the same, the gas or gas mixture being selected from the group consisting of argon, krypton, xenon, and neon and a mixture thereof; substantially saturating the citrus juice and/or precursor thereof; and maintaining the saturation substantially throughout the volume of the citrus juice and/or precursor thereof or the containing means and during satisfactorally all of the duration that the citrus juice or precursor thereof is in the containing means.

### BRIEF DESCRIPTION OF THE DRAWINGS

FIG. 1 schematically illustrates the production process of orange juice from oranges.

FIG. 2 illustrates a GC/MS of orange juice aroma volatiles under argon.

FIG. 3 illustrates a GC/MS of orange juice aroma volatiles under nitrogen.

FIG. 4 illustrates a GC/MS of orange juice aroma volatiles under oxygen.

### DETAILED DESCRIPTION OF THE PREFERRED EMBODIMENTS

In accordance with the present invention, a method is provided for preserving citrus juice or a precursor thereof by controlling the oxidative reactions which generally contribute to the degradation of citrus juices, particularly those involving ascorbic acid. Quite surprisingly, it has been discovered that this can be accomplished by contacting the citrus juice or precursor material thereof with a noble gas, mixture of noble gases or gas containing at least one noble gas during at least a portion of a production process for the citrus juice or storage of the juice or precursor.

As used herein, the term “noble gas” is intended to include argon, xenon, krypton and neon. Helium does not work, and radon is radioactive and not useful.

It is explicitly contemplated herein that the term “citrus” be interpreted as broadly as is scientifically recognized. Thus, lemons, oranges, limes, grapefruit, tangerines, and tangelos, for example, may be used.

In accordance with the present invention, argon, xenon, krypton and neon may be used alone or in any combination. For example, binary mixtures of argon-xenon, krypton-xenon or xenon-neon may be used, or ternary mixtures of argon-xenon-krypton may be used, for example.

However, mixtures containing at least one noble gas with one or more other carrier gases may also be used. Carrier gases may include, for example, nitrogen, carbon dioxide, nitrous oxide, helium and oxygen at low concentration. Preferably, however, the carrier gas is an inert gas, such as nitrogen.

Generally, the effect of the present invention may be obtained at a range of pressures form about near-vacuum, i.e., about 10⁻⁸ torr, to about 100 atmospheres. However, it is generally preferred that a pressure be used between about 0.001 to about 10 atmospheres, more preferably between about 0.001 to about 3 atmospheres. Further, a range of temperature is generally used which is from freezing temperatures to cooking temperatures, such as about −20° C. to about 300° C. However, lower temperatures and ambient temperatures are generally used for storage.

As noted above, a single noble gas, such as argon, or a mixture of noble gases may be used in accordance with the present invention. However, mixtures containing at least one noble gas and one or more carrier gases may also be used.

In accordance with the present invention, it has also been unexpectedly discovered that if instead of solely blanketing the headspace above a citrus juice or precursor stored in containing means, such as a tank or a bottle with any kind of inert gas, a gas or gas mixture containing an element selected from the group consisting of argon, krypton, xenon and neon or a mixture thereof is sparged into the citrus juice or precursor and/or injected above the citrus juice and/or precursor in order to saturate or substantially saturate said citrus juice and/or precursor with the gas or gas mixture, it is possible to substantially improve the color and/or the flavor and/or the aroma and/or the shelf life of the citrus juice and/or precursor, particularly when the saturation or substantial saturation is maintained throughout the volume of the storage container and during substantially all the time that the citrus juice and/or precursor is stored in said container.

The term “substantially saturate” means that it is not necessary to completely and/or constantly saturate the citrus juice and/or precursor with the gas or gas mixture (i.e., having the maximum amount of gas solubilized in the citrus juice and/or precursor). Usually, it is considered necessary to saturate the citrus juice and/or precursor to more than 50% of its (full) saturation level and preferably more than 70%, while 80% or more is considered the most adequate level of saturation of the citrus juice or precursor. Of course, supersaturation is also possible. This means that if during the storage life of the citrus juice or precursor in the container, the citrus juice or precursor is not saturated with noble gas at least from time to time or even quite longer if it remains generally substantially saturated, results according to the invention are usually obtained. While it is believed that it is important that the entire volume of the container be saturated or substantially saturated with one of the above gas or a mixture thereof, it is quite possible to obtain the results according to the invention if a part of the volume is not saturated during preferably a limited period of time or is less saturated or substantially saturated than other portions of the volume of the citrus juice or precursor in the container.

While at least one of the above gases must be present in order to obtain the benefits of the invention, said gases can be diluted with some other gases, in order to keep for example the invention economically valuable. Said diluent gases are preferably selected from the group comprising nitrogen, oxygen, nitrous oxide, air, helium or carbon dioxide. In case of an oxygen-containing gas or another reactive gas such as carbon dioxide, their degradative properties are such that these properties will mask the effect of noble gases, certainly in mixtures where they comprise 50% vol. or more and possibly 30% vol. or more. When those mixes comprise 0% to 10% vol. of these other gases, the noble gases referred to above are still extremely effective, while between 10% vol. and 20% vol. they are usually still effective, depending on the type of gases and conditions, which might be easily determined by the artisan.

In case of nitrogen and/or helium gas, the effect of noble gases consisting of Ar, Ne, Kr, Xe in the mixture is linearly proportional to its concentration in the mixture, which evidences that nitrogen and/or helium have no effect on substantially preventing oxidation of citrus juice and/or precursor thereof. The mixture of noble gas and nitrogen and/or helium can thus comprise any amount (% volume) of nitrogen and/or helium: however, in practice, the lesser the proportion of noble gas selected from the group consisting of Ar, Ne, Kr and Xe, the larger the time required to achieve saturation or substantial saturation of the citrus juice and/or precursor thereof.

Among the active gases (Ar, Kr, Xe, and Ne), it is preferred to use argon because it is cheaper than the other active gases. However, mixtures of argon and/or krypton and/or xenon are at least as effective as argon alone. It has also been unexpectedly found that mixtures comprising between 90 to 99% vol. argon and 1 to 10% Xe and/or Kr are usually the most effective as exemplified in the further examples (whether or not they are diluted with nitrogen, helium, or nitrous oxide). The difference in effect between the active gases defined hereabove and nitrogen have been also evidenced by the fact that mixtures of argon and oxygen or carbon dioxide have a similar (while decreased) effect than argon alone, while nitrogen mixed with oxygen or carbon dioxide evidenced no protective or preservative effect compared to oxygen or carbon dioxide alone.

It is believed that the saturation or substantial saturation of the citrus juice and/or precursor is an essential feature of the invention and that no one in the prior art has ever disclosed nor suggested said feature.

Generally speaking, Xe is the most efficient gas according to the invention, followed by Kr, Ar and Ne. Among the suitable mixes, either pure or diluted with N₂, He, N₂O (or even air, oxygen or a small amount of hydrogen) are the Ne/He mix comprising about 50% vol. of each, and the Kr/Xe mix comprising about 5-10% vol. Xe and about 90-95% vol. Kr, with a small amount of argon and/or oxygen (less than 2% vol.) or nitrogen (less than 1% vol.).

The temperatures at which the invention is carried out is usually between about 0° C. to 60° C., and preferably about 10° C. and 30° C.

The injection of the gas or gas mixture into the wine and/or into the container, e.g. by sparging is usually done at about 1 atmosphere but is still quite operable at 2 or 3 atmospheres, while saturation is increased at higher pressures. The pressure of the gas above the citrus juice and/or precursor in the container shall be, in any case, preferably lower than 10 atmospheres and it is usually acceptable to maintain it lower than 3 atmospheres.

Saturation or substantial saturation of the wine can be measured by various methods well-known by the man skilled in the art, including but not limited to thermogravimetric analysis or mass change weighting.

There are a variety of standard methods available for the detection, qualitative and quantitative measurement of gases, and several are especially well suited for the determination of degree of saturation of noble gases into liquid samples.

Samples generally are completely evacuated as a control for zero % saturation. Such samples may then be completely saturated by contact with noble gases such that no additional noble gas will disappear from a reservoir in contact with the sample. Such saturated samples may then have their gas content driven off by trapped evacuation or by increase in temperature, and said gas sample identified quantitatively and qualitatively. Analysis is of trapped gases, reservoir gases, or some other headspace of gases, not directly of the sample.

Direct sample analysis methods are available, and include comprehensive GC/MS analysis, or by mass or thermal conductance or GC analysis and comparison with calibrated standards.

The simplest method is GC/MS (gas chromatography/mass spectrometry), which directly determines gas compositions. By preparing a standard absorption curve into a given sample for a series of gases and mixtures, one can accurately determine the degree of saturation at any point in time.

GC/MS is applied to the gas itself, as in the headspace above a sample. The technique may be used either to determine the composition and quantity of gas or mixture being released from a sample, or conversely the composition and quantity of a gas or mixture being absorbed by a sample by following the disappearance of the gas.

Appropriate GC/MS methods include, for example, the use of a 5 Angstrom porous layer open tubular molecular sieve capillary glass column of 0.32 mm diameter and 25 meter length to achieve separation, isothermally e.g. at 75° C. or with any of several temperature ramping programs optimized for a given gas or mixture e.g. from 35-250° C., wherein ultra-high purity helium or hydrogen carrier gas is used at e.g. 1.0 cc/min flow rate, and gases are detected based upon their ionicity and quantitative presence in the sample, and characterized by their unique mass spectra.

Appropriate experimental conditions might include, for example, completely evacuating a given sample under vacuum to remove all absorbed and dissolved gases, then adding a gas or mixture to the sample and measuring a) the rate of uptake of each component as disappearance from the added gas, and/or b) the final composition of the gas headspace after equilibration. Both measurements are made by GC/MS, and either method can be used in both batch and continuous modes of operation.

A simplification of this analysis entails the use of a GC only, with a thermal conductivity detector, wherein adequate knowledge of the gas saturation process and preparation of calibration curves have been made such that quantification and characterization of gases and mixtures can be accomplished without mass spectral analysis. Such instruments are relatively inexpensive and portable.

A further simplification would depend solely upon measurement of the mass change in the sample upon uptake of various gases or mixtures, which depends upon the use of standard curves or absorption data available from the literature.

An alternate method for such mass measurements is thermogravimetric analysis, which is highly precise, wherein a sample is saturated with gas and mass changes are correlated to thermal change.

For example, in accordance with the present invention it is advantageous to use inexpensive production plant off stream gases having a composition of about 90% Kr and 10% Xe in volume %, based on the total gas volume or Ne:He 1:1.

It is also advantageous to use mixture containing an effective amount of one or more noble gases in deoxygenated air. Generally, as used herein, the term “deoxygenated air” is intended to mean air having generally less than 15 volume % or 10 volume %, preferably less than 5 volume % oxygen therein.

Further, the gas or gas mixtures of the present invention may be used as gases or may also be introduced into the citrus juice or precursor thereof or into the headspace or even above in storage means in order to form the described atmosphere.

Color improvement in the citrus juices is quite dramatic, which is, itself, a very surprising and significant improvement. Further, flavor is also improved according to a blind taste test of each product.

Storage of any citrus juice under any of the noble gases argon, xenon, krypton, neon, alone or in mixtures, or admixed with nitrogen or small amounts of oxygen or carbon dioxide or nitrous oxide greatly, and surprisingly, improve the retardation of oxidation as compared to that obtainable using nitrogen.

As already noted, the effect of the present invention is demonstrated over a wide range of temperatures, including during cooking or pasteurization, refrigeration, and freezing, including cryogenic freezing. It is also observed under low or very high pressures.

Generally, the advantages of the present invention may be obtained by contacting whole citrus fruit, portions of citrus fruit, concentrate and/or juice with the gases of the present invention at any, and preferably every, stage of the production process beginning with the peeling of the fruit.

As used herein, the term “precursor” means any natural product which may serve as a source of citrus juice or as a flavoring additive for citrus juice. Examples of precursors are whole citrus fruit, portions of the fruit including flesh, seeds or rinds or even citrus oils or citrus blossoms.

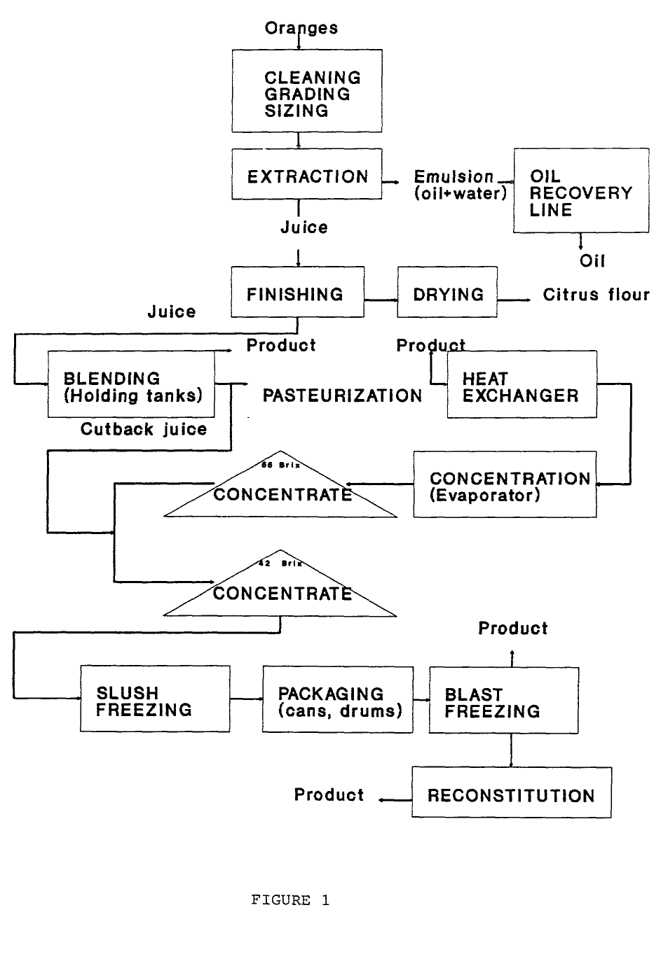

In order to further describe the present invention, the following typical production process for frozen concentrated orange juice will now be described solely to illustrate the present invention without limiting the same. This process is illustrated by reference to FIG. 1.

Step 1: Unloading system for trucks.

Step 2: Storage facilities (e.g., water basin storage system) and cleaning, grading, and sizing of oranges.

Step 3: Orange peel is rich in a very automatic oil, which if present in large quantities, gives a bitter taste to the juice. Nevertheless a small amount of oil is necessary to give orange juice its original taste. Furthermore, orange essential oil is a product with a non-negligible added value, since it is used in other products as an aroma chemical. Therefore, the juice extraction machinery is designed to insure an adequate separation of the juice from the peel oil.

This first step in the extraction process is to remove the peel external layer by passing the oranges through a scarifier. The oil is transported as an emulsion (formed by spraying water) to the essential oils recovery line, where it is centrifuged.

Scarified oranges go through the juice extractor.

Step 4: Seeds and large particles such as the membrane and the core of the fruit are separated from the juice and small pulp particles through the finishing step.

Step 5: The juice in then pumped to holding tanks, where it can be blended in order to achieve uniformity (standardized color and total solids; standardized sugar and acid contents).

Step 6: The pasteurization step, which is used when marketing “pasteurized” juice, consists of heating the juice to 145-160° F. for 5-30 seconds. It results in inactivation of pectinesterase and in reduction of the microbial flora. Heat treating steps are severely controlled in attempting to minimize the loss of fresh flavor.

In some processes, the juice is depulped prior to evaporation. After being preheated to 80° C. in a plate preheater, the amount of pulp is reduced from 10% to 1-2% by centrifugation. The juice is then cooled down to 50-60° C. in a heat exchanger.

Step 7: The juice is preheated by flowing through a heat exchanger before reaching the evaporator.

Step 8: Concentration of the juice is achieved by evaporation, which is done under vacuum and at the lowest temperature possible to avoid the development of a cooked flavor. Evaporation results in unavoidable loss of flavor. The juice is concentrated past (55°—Brix) to the commercial concentration level (42°—Brix).

To solve the problem of loss of flavor volatiles during the evaporation, several industrial alternatives have been considered.

Some recovery processes (e.g. distillation) of the flavor from the first stage of the evaporation are commercially used. The resulting flavor essence can be added back to the final product.

Concentration can be achieved by other means than evaporation, such as freeze concentration, reverse osmosis or filtration through selective membranes, which are low temperature processes. In these cases there is no heat-induced enzymatic inactivation.

Freeze concentration can be achieved in various ways. The juice can be passed through a scraped surface heat exchanger, or frozen by direct contact with a cryogenic liquid such as liquid nitrogen. Separation of the ice from the orange slurry is done by centrifugation or column washing to yield the concentrate. Freeze concentration causes a problem of solids loss.

Step 9: To counterbalance the loss in flavor, a determined percentage of fresh untreated juice is added to the overconcentrated juice. The final product has a percentage of solid concentrate of 42% (42°—Brix) and a flavor closer to that of fresh orange juice.

Step 10: The concentrate is transformed to a slush by passing it through a chilled scraped surface heat exchanger. It is then frozen solid after being packaged into containers (e.g., cans, or drums for further industrial use).

Step 11: The by-products of this process (50% of the orange) are the dried peel (animal feed), citrus molasses (concentrated waste water), oil (flavor chemical), citrus flour (dried pulp, albedo, core, membranes).

Further Processing: Citrus Fruit Juice Reconstituted from Concentrate

The water used for the reconstitution from the orange or other citrus concentrate is treated by passing through a pressurizing group, a dechlorination filter, and a sterilizing station.

Sugar is weighed, melted in a sugar melting tank, and passed through a syrup filter.

Concentrate is pumped, weighed, and mixed in the appropriate ratio with the syrup in mixing tanks.

The reconstituted fruit juice is then pasteurized through a heat exchanger, packaged and cooled down in a cooling tunnel.

The orange or other citrus juice is packaged and cooled down after step 6 of the above described Concentrate Production Process.

The present invention thus provides many advantageous aspects, some of which may be noted.

First processing and storage of orange or other citrus juice under any of the noble gases argon, xenon, krypton, neon, alone or in mixtures, or admixed with nitrogen or small amounts of oxygen or CO₂ or N₂ or He, greatly, and surprisingly, improve the retardation of oxidation as compared to that obtainable using nitrogen.

Second contacting the fruit or juice at any of the processing steps of peeling, extraction, pressing, separation, pumping, blending, holding storage, depulping, pasteurization, heating, evaporating, concentrating, freeze-concentrating, reblending, aroma recovery, reconstitution, or further processing, with noble gases greatly improves the flavor and fragrance, appearance, color, and quality of the intermediate and final products.

This improvement is demonstrated at a wide range of temperatures, including during heating or pasteurization, refrigeration, and freezing, including cryogenic freezing, and is effective under low or very high pressures.

Additionally, the noble gases, preferably argon, are more effective than nitrogen or carbon dioxide, and the effect is directly proportional to the degree of saturation of the product with noble gas.

Having generally described the present invention, reference will now be made to certain examples which are provided solely for purposes of illustration and which are not intended to be limitative.

### EXAMPLE

Several varieties of orange or other citrus juice including fresh squeezed, reconstituted from concentrate, and pasteurized versions of these, were subjected to GC/MS analysis of headspace after being stored variously under Ar, Xe, Kr, Ne, He, N₂, CO₂, N₂O, O₂, Air, and decile binary and ternary combinations of these gases.

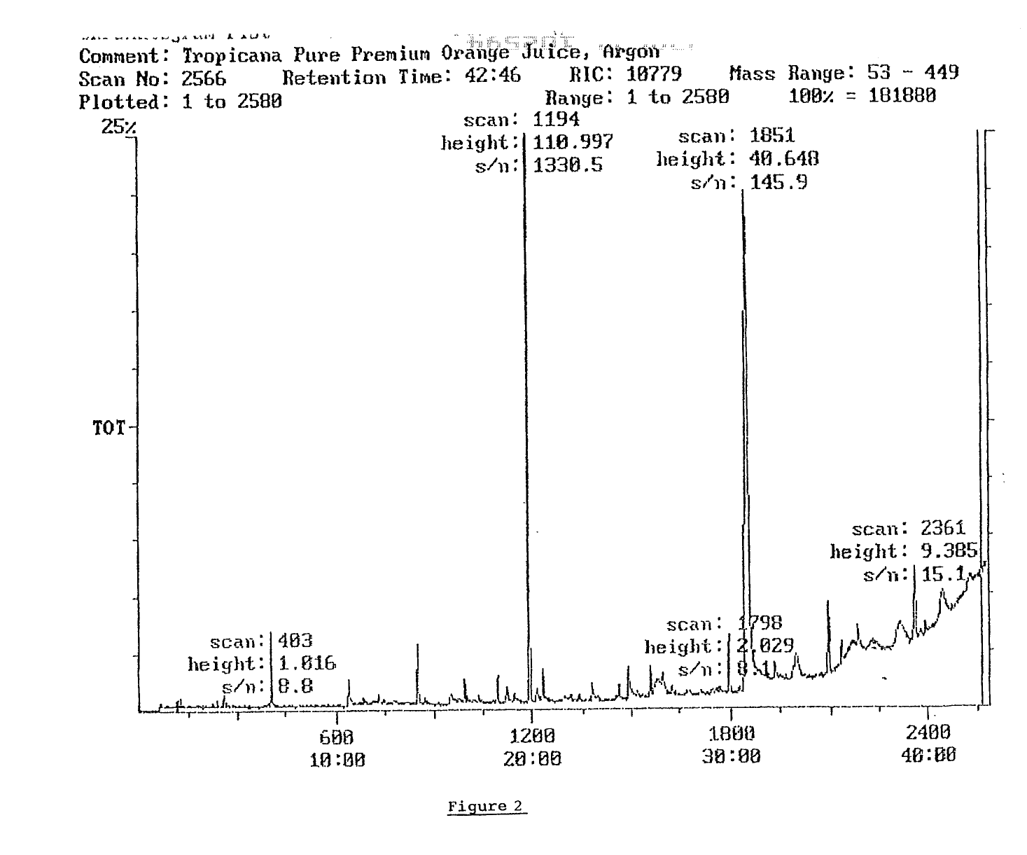

FIG. 2 illustrates a GC/MS of orange juice aroma volatiles under argon. The various parameters applicable are recited on FIG. 2.

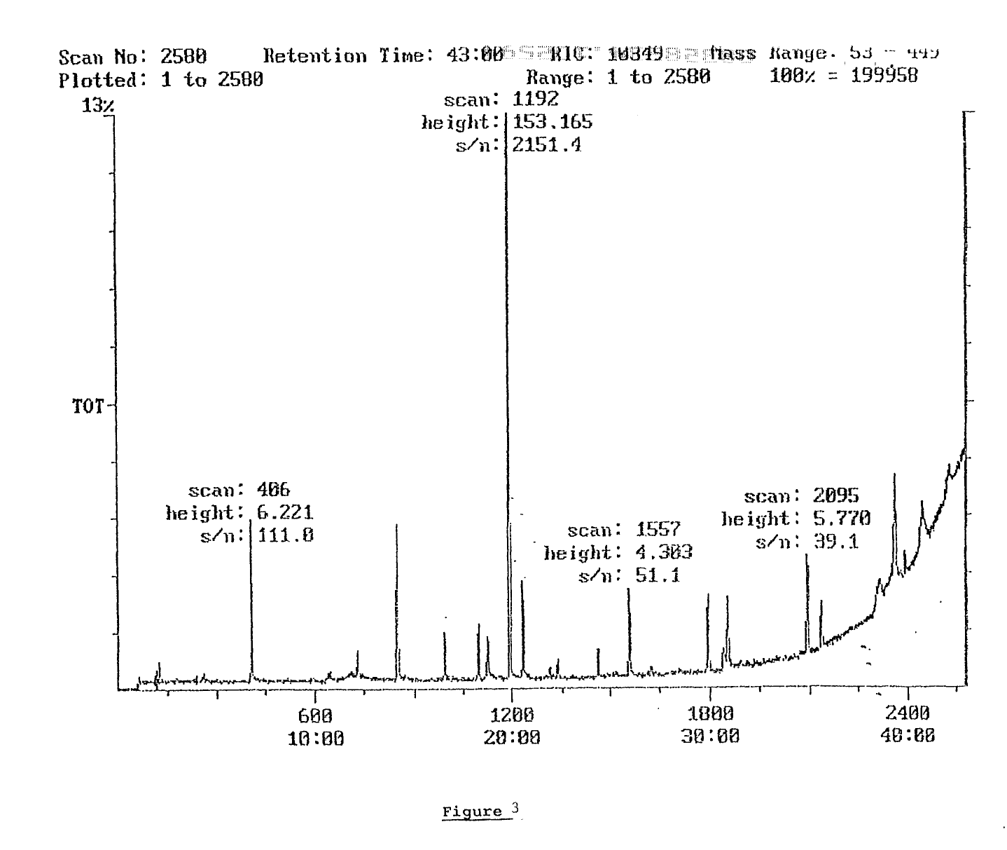

FIG. 3 illustrates a GC/MS of orange juice aroma volatiles under nitrogen. The various parameters applicable are recited on FIG. 3.

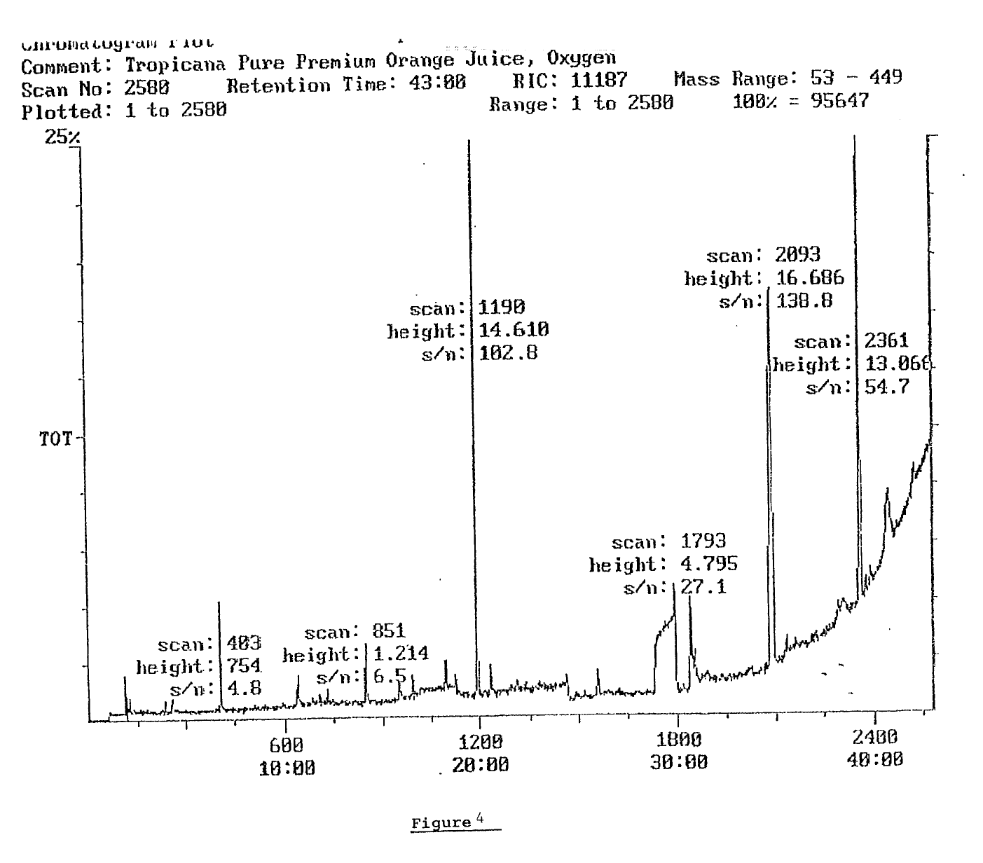

FIG. 4 illustrates a GC/MS of orange juice aroma volatiles under oxygen. The various parameters applicable are recited on FIG. 4.

From a comparison of FIGS. 2, 3 and 4, the damaging effect of oxygen may be seen, whereas the surprisingly superior effect of argon as compared to nitrogen may be seen.

Marked are the cyclohexanetetrol and tridecane peaks around 1853 seconds, which are well preserved in argon, much oxidized in nitrogen and very much oxidized in oxygen (also present is considerable siloxane column bleed).

For example, the glycosides present in the argon sample which produce peaks at 1570-1596 seconds are oxidized and not present at all in the oxygen sample, and present in trace quantities in the nitrogen sample. The same progressive oxidation differences are observed for the nitrile at 870 secs, the acid esters at 1040 secs, the pyrans at 1149 secs, the substituted cyclohexanone at 1217 secs, the substituted propanol at 1378 secs, and the substituted cyclohexane at 1490 secs (identifications tentative from NBS data library).

A sum of differences method was used to average quantitative improvement across many compounds, and it was observed that, generally, a 25-30% improvement in shelf life can be easily obtained using argon, for example, in accordance with the present invention.

In order to further illustrate the effect of the present invention, the various gases and gas mixtures as noted in Tables I and II were used as storage gases for orange juice.

In the following two tables, the color of the orange juice was measured by uv/vis spectrophotometer methodology, the flavor and aroma by GC/MS method and shelf life by GC/MJ methodology. The relative progress of oxidation over time using the gases and gas mixtures of the present invention was compared with air, oxygen or nitrogen storage.

An organoleptic/sensory panel of five persons tasted through blind samples the color, flavor and aroma which are congruent with and contain the above instrumental measurements.

Tables I and II follow:

TABLE I
Orange Juice Evaluation
Effect of different gas storage atmosphere

| | | Flavor |
|---|---|---|
| Gas Mixes | Color | Aroma |
| N₂ | 64 | 60 |
| Ar | 92 | 93 |
| Ar:Kr 9:1 | 95 | 96 |
| Ar:Ne 9:1 | 93 | 92 |
| Ar:Xe 9:1 | 100 | 100 |
| Ar:Xe 99:1 | 99 | 98 |
| He | 65 | 63 |
| Ne | 85 | 87 |
| Kr | 93 | 94 |
| Xe | 100 | 100 |
| Air | 20 | 35 |
| O₂ | 0 | 0 |
| N₂:0₂ 9:1 | 30 | 35 |
| Ar:0₂ 9:1 | 85 | 90 |
| CO₂ | 30 | 55 |
| N₂:CO₂ 8:2 | 30 | 45 |
| Ar:CO₂ 8:2 | 50 | 70 |

Relative scaling of effect compared to oxygen, set to 0.

TABLE II
Orange Juice
Gas Mixtures in decile combination trials, as:

| | | Flavor |
|---|---|---|
| Gas Mixtures | Color | Aroma |
| Ar:N₂ | | |
| 100:0 | 92 | 93 |
| 80:20 | 86 | 88 |
| 50:50 | 77 | 79 |
| 20:80 | 68 | 72 |
| Ar:He | | |
| 100:0 | 92 | 93 |
| 80:20 | 87 | 88 |
| 50:50 | 75 | 76 |
| 20:80 | 66 | 71 |
| N₂:O₂ | | |
| 100:0 | 64 | 60 |
| 90:10 | 30 | 35 |
| 80:20 | 20 | 20 |
| 70:30 | 0 | 0 |
| Ar:O₂ | | |
| 100:0 | 92 | 93 |
| 90:10 | 85 | 90 |
| 80:20 | 70 | 78 |
| 70:30 | 60 | 65 |
| Ar:Kr:Xe | | |
| 60:20:20 | 100 | |

Relative scaling of effect compared to oxygen, set to 0.

As used herein, the term “substantially” generally means at least 75%, preferrably at least about 90%, and more preferably about 95%. This refers not only to duration of storage but also the volume of the containing means.

Having described the present invention, it will now be apparent to one of ordinary skill in the art that many changes and modifications may be made without departing from the specification and the scope of the present invention.

What is claimed as new and desired to be secured by Letters Patent of the United States is:

1. A method of improving the aromas or the flavor or both of a citrus juice or precursor thereof, comprising injecting a gas or gas mixture into the citrus juice or precursor thereof or both in containing means or into containing means therefor, the gas or gas mixture containing an element selected from the group consisting of argon, krypton, xenon, neon and a mixture thereof; substantially saturating the citrus juice or precursor thereof with said gas or gas mixture, maintaining said saturation substantially throughout the volume of the containing means and during substantially all the duration the citrus juice or precursor stored in said container.

2. The method according to claim 1, wherein said gas is injected in gaseous form and/or liquid form.

3. The method according to claim 1, wherein said wine is saturated to more than 50% volume of its full saturation level.

4. The method according to claim 1, wherein said wine is saturated to more than 70% volume of its full saturation level.

5. The method according to claim 1, wherein said wine is saturated to more than 80% volume of its full saturation level.

6. The method according to claim 1, wherein said gas mixture additionally comprises a gas selected from the group comprising nitrogen, oxygen, nitrous oxide, air, helium, carbon dioxide or mixtures thereof.

7. The method according to claim 6, comprising less than 50% volume of oxygen, carbon dioxide, or a mixture thereof.

8. The method according to claim 6, comprising less than 30% volume of oxygen, carbon dioxide, or mixture thereof.

9. The method according to claim 6, comprising less than 20% volume of oxygen, carbon dioxide, or mixture thereof.

10. The method according to claim 6, comprising less than 10% volume of oxygen, carbon dioxide, or mixture thereof.

11. The method according to claim 1, wherein the gas mixture or the element of the gas mixture comprises 90% to 99% volume argon and 1% to 10% volume Xe and/or Kr.

12. The method according to claim 1, wherein the gas mixture or the element of the mixture comprises about 50% volume Ne and 50% volume He.

13. The method according to claim 1, wherein the gas mixture or the element of the gas mixture comprises about 5% to 10% volume Xe and 90% to 95% volume Kr.

14. The method according to claim 13, wherein the gas mixture comprises less than 2% volume of argon, oxygen, nitrogen or a mixture thereof.

15. The method according to claim 1, wherein the temperature is comprised between 0° C. and 40° C.

16. Th method according to claim 1, wherein the temperature is comprised between 10° C. and 30° C.

17. The method according to claim 1, wherein the pressure of the citrus juice or precursor is less than 10 atmospheres.

18. The method according to claim 1, wherein the pressure of the citrus juice or precursor is less than 3 atmospheres.

19. The method according to claim 1, wherein the pressure of the citrus juice or precursor is between 1 and 2 atmospheres.

20. The method according to claim 1, wherein the pressure of the citrus juice or precursor is about 1 atmosphere.

21. A method improving process for producing citrus juice, comprising injecting a gas or gas mixture into the citrus juice or precursor hereof or both in containing means or into containing means thereof during the process for producing the citrus juice, the gas or gas mixture containing an element selected from the group consisting of argon, krypton, xenon, and neon, and a mixture thereof; substantially saturating the citrus juice or precursor thereof with the gas or gas mixture; and maintaining the saturation substantially throughout the volume of the containing means and during substantially through he duration of the process by which the citrus juice is produced.

22. The method according to claim 21, wherein said gas is injected in gaseous form or liquid form or both.

23. The method according to claim 21, wherein said wine is saturated to more than 50% volume of its full saturation level.

24. The method according to claim 21, wherein said wine is saturated to more than 70% volume of its full saturation level.

25. The method according to claim 21, wherein said wine is saturated to more than 80% volume of its full saturation level.

26. The method according claim 21, wherein said gas mixture additionally comprises a gas selected from the group comprising nitrogen, oxygen, nitrous oxide, air, helium, carbon dioxide or mixtures thereof.

27. The method according to claim 6, comprising less than 50% volume of oxygen, carbon dioxide or a mixture thereof.

28. The method according to claim 6, comprising less than 30 volume of oxygen, carbon dioxide, or mixture thereof.

29. The method according to claim 6, comprising less than 20% volume of oxygen, carbon dioxide, or mixture thereof.

30. The method according to claim 6, comprising less than 10% volume oxygen, carbon dioxide, or mixture thereof.

31. The method according to claim 21, wherein the gas mixture or the element of the gas mixture comprises 90% to 99% volume argon and 1% to 10% volume Xe and/or Kr.

32. The method according to claim 21, wherein the gas mixture or the element of the gas mixture comprises about 50% volume Ne and 50% volume He.

33. The method according to claim 21, wherein the gas mixture or the element of the gas mixture comprises about 5% to 10% volume Xe and 90% to 95% volume Kr.

34. The method according to claim 13, wherein the gas mixture comprises less than 2% volume of argon, oxygen, nitrogen, or a mixture thereof.

35. The method according to claim 21, wherein the temperature is comprised between 0° C. and 40° C.

36. The method according to claim 21, wherein the temperature is comprised between 10° C. and 30° C.

37. The method according to claim 21, wherein the pressure of the citrus juice or precursor is less than 10 atmospheres.

38. Th method ac ding to claim 21, wherein the pressure of the citrus juice or precursor is less than 3 atmospheres.

39. The method according to claim 21, wherein the pressure of the citrus juice or precursor is between 1 and 2 atmospheres.

40. The method according to claim 21, wherein the pressure of the citrus juice or precursor is about 1 atmosphere.
